(19) United States
(12) Patent Application Publication
(10) Pub. No.: US 2025/0058985 A1
(43) Pub. Date: Feb. 20, 2025

(54) TRANSFER STATION FOR LOADS IN LOGISTICS FACILITIES

(71) Applicant: Jungheinrich Aktiengesellschaft, Hamburg (DE)

(72) Inventor: Joachim Gether, Großwilfersdorf (AT)

(21) Appl. No.: 18/792,703

(22) Filed: Aug. 2, 2024

(30) Foreign Application Priority Data
Aug. 17, 2023 (EP) 23191953.1

(51) Int. Cl. B65G 67/08; B65G 43/08; B65G 67/24; G06Q 10/08

(52) U.S. Cl. CPC B65G 67/08; B65G 43/08; B65G 67/24; G06Q 10/08; B65G 2203/0233; B65G 2203/0283; B65G 2203/044; B65G 2811/093

(57) ABSTRACT

The present invention relates to a transfer station (100) for loads in logistics facilities, comprising at least two transfer points (102, 104) of different types for loads, which are configured in such a way that a load transport vehicle (200, 300) of an associated vehicle type can acquire and release each load, comprising a conveyor unit (108) which is configured to transport loads between the at least two transfer points (102, 104), and comprising a self-sufficient electrical system with a control unit (110) which is configured to be supplied with electrical energy from outside and to automatically control the operation of the conveyor unit (108).

The present invention relates to a transfer station for loads in logistics facilities, to a system formed from such a transfer station, and to at least two load transport vehicles of different types, and to a method for operating such a system.

Logistics facilities often use different types of load transport vehicles that perform different tasks and/or travel to different areas of the facility, and between which loads to be transported must be transferred. For example, in practice, there are scenarios in which objects, such as loaded pallets, are transported by pallet shuttles in a first area of a warehouse and are then received by a corresponding narrow-aisle vehicle and/or storage and retrieval machine for storage in a high-bay rack, and vice versa. For example, the vehicle types mentioned can each be automated and controlled and monitored by a single warehouse management system, although variants are also conceivable in which at least one of the vehicles is controlled by a human operator. Generally speaking, the horizontal transport of goods in such a logistics environment can be carried out by means of a first type of vehicle, whereas the storage of the corresponding goods in a shelf and, in a similar way, their removal from the shelf is then carried out by another type of vehicle with a vertical mast.

However, such different vehicle types are also characterized by the fact that they pick up and carry corresponding objects in different ways. For example, in the application of a pallet shuttle and a narrow-aisle forklift truck just described, pallet shuttles carry corresponding loads on a height-adjustable load-carrying platform on their top side, and move under them to pick them up, whereas narrow-aisle vehicles with corresponding vertical masts are equipped with load-handling devices, such as load-carrying forks, which can be inserted into pallet gaps to pick them up.

This shows that a direct transfer of corresponding goods between the different vehicle types is usually not possible, or at least is inefficient due to the different load handling equipment, since in such cases the vehicles in question would have to wait for each other before the loads can be transferred. Although in the example just mentioned, pallet shuttles and storage and retrieval machines have been mentioned as possible types of vehicles between which such a transfer of loads must be carried out, cases are also conceivable in which, for example, loads must be placed manually using ordinary, person-operated forklifts and then acquired by storage and retrieval machines or the like. It should be noted that, particularly when using a pallet shuttle as a vehicle type, it is not possible to simply put down the load, for example a pallet. The load must therefore be transferred directly to another vehicle or into a rack.

Although transfer stations have already been used for such purposes, which enable different types of vehicles to place loads on them and/or to acquire such loads from them, such static transfer stations with a single transfer point are purely passive components in a logistics facility and cannot contribute to improved and more effective handling of loads.

It is therefore the object of the present invention to provide a transfer station for loads in logistics facilities which enables a transfer of loads between different types of vehicles in a simple and—compared to the known prior art—more efficient manner, and can nevertheless be operated independently, i.e. without the need for integration into a higher-level warehouse management system or the like.

To achieve this object and for this purpose, the transfer station for loads in logistics facilities according to the invention comprises at least two transfer points of different types for loads, which transfer points are configured in such a way that a load can be acquired and released by a load transport vehicle of an associated vehicle type, a conveyor unit which is configured to transport loads between the at least two transfer points, and a self-sufficient electrical system with a control unit which is configured to be supplied with electrical energy from outside and to automatically control the operation of the conveyor unit.

Accordingly, the transfer station according to the invention provides a device which enables different vehicle types to acquire loads from transfer points of a corresponding type assigned to them or to release the loads onto the transfer points, while the conveyor unit further ensures that the corresponding loads can be transferred between the at least two transfer points. Furthermore, the provision of the self-sufficient electrical system ensures that the associated control unit can control and ensure the operation of the transfer station in the desired manner even without a connection to a higher-level management system. Accordingly, the transfer station according to the invention can be understood as a “standalone” solution with “plug and play” functionality.

In contrast to known conveyor systems with transfer stations, which have to be laboriously integrated into a warehouse storage system and the associated warehouse management system, the transfer station according to the invention allows for extremely simple integration into an existing storage system, as the station is configured at the operating site and is immediately ready for use after being connected to the power supply. In particular, it is intended that the transfer station does not require any control or sensor signals for its operation that are not provided by the integrated control unit or sensors of the transfer station itself. There is therefore no need to connect signal lines to additional facilities.

In this case, the conveyor unit of the transfer station according to the invention can be formed in particular by a chain conveyor with continuous chains, wherein the load can be transferred in different directions between the individual transfer points according to the operating direction of the chain conveyor.

Furthermore, the conveyor unit of the transfer station can comprise a motor with contactor control, preferably without a frequency converter or electronic controller, wherein a particularly robust design of the electrical functionality of the transfer station can be ensured with little construction effort.

Furthermore, each of the transfer points of the transfer station according to the invention can be assigned an occupancy sensor which is configured to supply data to the control unit which indicate whether the corresponding transfer point is occupied by a load. This can prevent a malfunction of the transfer station, for example by preventing the conveyor unit from being put into operation by the control unit as long as a load is located at a transfer point to which another load is to be transferred at the same time. Such occupancy sensors can be formed, for example, by suitable light barrier units or, for example, by weight sensors, each of which is suitable for determining the presence of a load at a predetermined location, in this case the corresponding transfer point.

Alternatively or additionally, the transfer station according to the invention can comprise at least one surroundings sensor, for example designed as an ultrasonic sensor, light barrier or capacitive sensor, which is configured to supply data to the control unit which indicate whether a load transport vehicle is present in the vicinity of at least one of the transfer points. This provision of at least one surroundings sensor also serves as a safety measure in the present invention, since it can thereby be ensured, for example, that the conveyor unit is only put into operation when there is no longer a load transport vehicle within the detection range of the corresponding at least one surroundings sensor, so that possible malfunctions can be ruled out from the outset even in such situations. In particular, this can prevent the transfer station from starting a transport before the vehicle has completed the release or acquisition process for a load.

Furthermore, the transfer station according to the invention can comprise at least one position sensor, for example implemented by a light barrier, which is configured to indicate when a specified load position has been reached during transport of a load. By providing such a position sensor, it can be ensured that a corresponding load is always reliably transported to a precisely specified position at one of the transfer points, wherein, for example, inaccuracies can be compensated for that may occur if the load is not placed precisely at one of the other transfer points by a corresponding vehicle.

In this context, the transfer station can further comprise a timer unit which is configured to trigger a predetermined runout time when a load reaches the position sensor, during which time the conveyor unit continues to operate. This allows a more free positioning of the position sensor. In particular, it does not necessarily have to be arranged at a position at which the corresponding load must come to a stop immediately during a transfer process between two transfer points; rather, it can also be offset by a certain distance from this intended position of the load, wherein the corresponding distance can be compensated for on the basis of the predetermined runout time.

As already indicated above, the transfer station according to the invention can further be configured in particular to enable a transfer of loads between a pallet shuttle and a storage and retrieval machine and/or a narrow-aisle forklift, so that at least one of the transfer points can be configured in such a way that a pallet shuttle can pass below a load carried thereon and/or a load can be placed thereon by a pallet shuttle, and/or at least one of the transfer points can be configured in such a way that a load carried thereon can be acquired by a storage and retrieval machine and/or a narrow-aisle forklift and/or a load can be placed thereon by a storage and retrieval machine and/or a narrow-aisle forklift. As already indicated above, the corresponding pallet shuttles, storage and retrieval machines, and/or narrow-aisle forklifts can each be designed as autonomous industrial trucks.

Furthermore, at least one of the transfer points can be provided with a stop which is configured to serve as a support for a load in a correct pose for acquisition by a load transport vehicle. Here, the term “pose” describes both the position and the orientation of the corresponding load, wherein an elongated rod or a bent sheet can be used as a corresponding stop, which can determine both the position and the orientation of the corresponding load after a transfer by the conveyor unit.

Alternatively or additionally, the transfer station according to the invention can further comprise at least one intermediate position which is arranged on the transport path of the conveyor unit between two of the transfer points and is intended to temporarily receive a load. However, the intermediate position does not simply refer to any position of a load that is currently in motion between two of the transfer points during a transfer process, but specifically to another position in which a load can be temporarily stored for a longer period of time before it is transferred on to one of the transfer points. Thus, the transfer station can act as a buffer unit in a corresponding logistics facility, wherein an occupancy sensor can again be assigned to the at least one intermediate position in the manner described above in order to ensure at this point too that the conveyor unit is not operated in a state of the transfer station in which one of the positions is already occupied by a load, which could lead to malfunctions or accidents.

According to a second aspect, the present invention relates to a system composed of a transfer station according to the invention of the type just described and at least two load transport vehicles of different types, which can in particular be selected from a pallet shuttle, a storage and retrieval machine, and a narrow-aisle forklift.

The system may further comprise a warehouse management system, wherein information about loads acquired or released at the transfer station is only transmitted from the load transport vehicles to the warehouse management system. As a result, the current occupancy status of the transfer station and the transfer points provided there is known to the warehouse management system only because the corresponding vehicles have reported the transfer and/or acquisition of a corresponding load from or to the transfer station to the warehouse management system, while the transfer station itself can operate completely in isolation and self-sufficiently in terms of its function. Accordingly, no data connections are necessary between the transfer station and the warehouse management system, and the transfer station itself can be put into operation by simply connecting it to a power supply, since the associated control unit can instruct and control the intended operating processes of the transfer station even without external data input.

Accordingly, in this context it may only be necessary to store the transfer station in the warehouse management system in such a way that the corresponding load transport vehicles can interact with it in a suitable manner, i.e., know its position and functionality, although neither communication of the load transport vehicles with the transfer station nor of the warehouse management system with the transfer station is necessary. The information as to whether one or more loads are currently present at the transfer station can therefore be derived solely by the warehouse management system on the basis of the information provided by the load transport vehicles regarding release and acquisition processes, wherein the warehouse management system can then take the loading status of the transfer station into account when planning further operational processes, and can coordinate the corresponding work orders to load transport vehicles accordingly.

According to a further aspect, the present invention relates to a method for operating such a system for transferring a load from a first load transport vehicle of a first type to a second load transport vehicle of a second type, comprising the steps of releasing the load at a first of the transfer points by the first vehicle, detecting the presence of the load by means of the occupancy sensor assigned to the first transfer point, operating the conveyor unit to transport the load from the first transfer point in the direction of a second of the transfer points if the occupancy sensor assigned to the second transfer point does not detect a load present there, detecting that the load has reached the second transfer point by means of the position sensor, ending the operation of the conveyor unit, and acquiring the load at the second transfer point by the second load transport vehicle.

This makes it clear that the intended functionality of the system according to the invention can be carried out simply by detecting the presence or absence of a load at the respective transfer points. Furthermore, it should be noted at this point and also with reference to possible concrete embodiments of the transfer station according to the invention that the position sensor assigned to one of the transfer points can simultaneously also fulfill the function of a corresponding occupancy sensor, provided that a corresponding mounting position is maintained which can ensure both the presence of a load and its correct positioning during a transfer process. Of course, embodiments are also conceivable in which the two sensors are implemented as separate detection units. Furthermore, it should be noted that where the timer unit described above is provided, the operation of the conveyor unit can be terminated with a delay according to the predetermined runout time after the position sensor has detected that the load has reached the corresponding second transfer point.

Furthermore, the method according to the invention can comprise transmitting information regarding the release of the load at the first transfer point to the warehouse management system, by the first load transport vehicle, and/or transmitting information regarding the acquisition of the load at the second transfer point to the warehouse management system, by the second load transport vehicle. This measure enables the advantageous integration of the transfer station in the logistics facility with regard to the method according to the invention, within the framework of a “standalone” operation in the manner described above.

Finally, the method according to the invention can further comprise, before the operation of the conveyor unit, a step of checking the surroundings of the first transfer point for the absence of the first load transport vehicle, for which purpose the surroundings sensor also already described above can be used at the first transfer point.

Further features and advantages of the present invention will become more apparent from the following description of an embodiment, when this is considered together with the accompanying figures. In the figures, in detail:

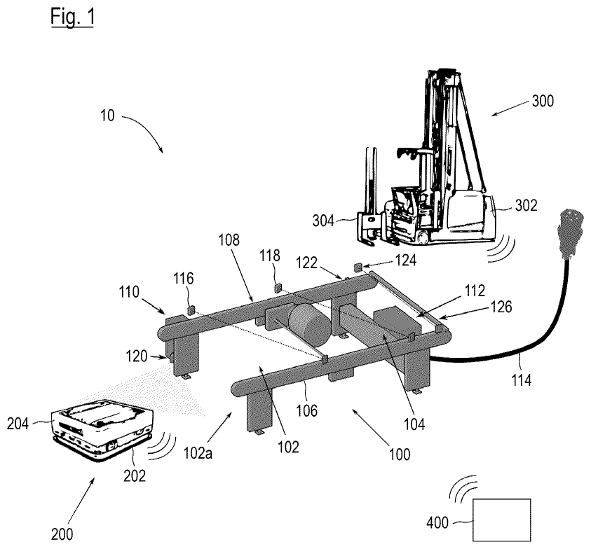

FIG. 1 is a schematic view of a system according to the invention, having a transfer station according to the invention and two transport vehicles of different vehicle types; and

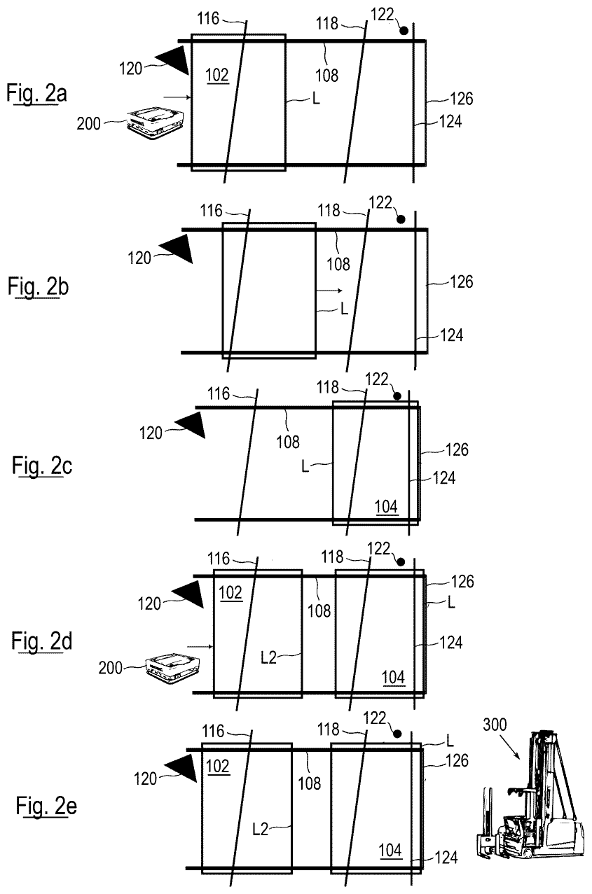

FIGS. 2a to 2e show a schematic representation of an operating sequence in the system of FIG. 1 according to a method according to the invention.

In FIG. 1, a system according to the invention is shown in a purely schematic representation, designated generally by the reference numeral 10. This system comprises a transfer station 100, a pallet shuttle 200 and a storage and retrieval machine 300, wherein the pallet shuttle 200 and the storage and retrieval machine 300 are to be understood as examples of different types of load transport vehicles which can be combined with the transfer station 100 to form the system 10.

Here, the pallet shuttle 200 is designed in a manner known per se, having a vehicle body 202 which accommodates a propulsion system (not shown here in more detail) with a plurality of wheels, and a load-carrying platform 204, the height of which can be adjusted relative to the vehicle body 202, and on which a load can be transported during a transport operation of the pallet shuttle 200, for example a pallet loaded with objects. In this case, a transport process for such a load by the pallet shuttle 200 takes place in such a way that the corresponding load is first acquired from below in a suitable transfer station and then the load carrying platform 204 is displaced vertically upwards relative to the vehicle body 202 until the load has been lifted from the transfer station. The load can then be transported, lying on the load carrying platform 204, by the pallet shuttle 200 to a release position and/or a further transfer station.

In contrast, the narrow-aisle forklift 300 is also provided in a manner known per se with a vehicle body 302 and a load-handling device 304, which in the example shown here is designed as a three-way load fork with sideshift. Accordingly, the narrow-aisle forklift 300 is particularly suitable for storing and retrieving objects in narrow-aisle high bays, wherein both manned and autonomous variants of such storage and retrieval machines 300 are known.

In order to enable a transfer of objects initially carried by the pallet shuttle 200, in particular pallets, to the narrow-aisle forklift 300, the system 10 comprises the aforementioned transfer station 100, which is provided with two transfer points 102 and 104 of different types, wherein the first transfer point 102 enables the pallet shuttle 200 to acquire a load from below, or release a load. This is because, in portion 102a, it can pass under the side arms 106 of the transfer station 100, whereas the second transfer point 104 enables a corresponding load to be acquired by means of the load-handling device 304 of the narrow-aisle forklift 300.

In the region of the frame 106 of the transfer station 100, a conveyor unit 108, shown here only schematically, is provided in the form of a chain conveyor with continuous chains and a motor with contactor control, which enables a transfer of a load from the first transfer point 102 to the second transfer point 104 and vice versa, according to the direction of rotation of the chains.

The control of the operation of the conveyor unit 108 is carried out by a control unit 110, which in the illustration in FIG. 1 is accommodated in an electronic part, which also includes control elements for a human operator, such as an emergency stop switch, an automatic start button, and the option of manually starting up the conveyor unit. Furthermore, the transfer station 100 comprises a connection box 112 with a power cable 114, wherein in the embodiment shown here, in order to put the transfer station 100 into operation, only the connection of the power cable 114 to a corresponding power network is necessary; no further connections need be provided—in particular no data connections.

Furthermore, the transfer station 100 comprises two occupancy sensors 116 and 118, which are each configured to supply data to the control unit 110 indicating whether the corresponding assigned transfer point 102 or 104 is currently occupied by a load. Possible embodiments of such occupancy sensors can be light barriers, which are interrupted when a load is present at the corresponding transfer point 102 or 104.

Furthermore, a surroundings sensor is provided at each end of the transfer station 10—in the present case an ultrasonic sensor 120 for the first transfer point 102 and a capacitive sensor 122 for the second transfer point 104. These two surroundings sensors 120 and 122 are each configured to supply data to the control unit 110 which indicate whether a load transport vehicle 200 or 300 is currently present in the vicinity of the given transfer point 102 or 104 or whether this vicinity is free of vehicles or other objects.

In addition, a position sensor 124 in the form of a further light barrier is provided in the area of the second transfer point 104, which, when a load is transported from the first transfer point 102 to the second transfer point 104 by means of the conveyor unit 108, detects when the corresponding transfer point 104 or an end position of the corresponding load transfer is reached, and delivers a corresponding signal to the control unit 110, on the basis of which the operation of the conveyor unit 108 can be terminated in such a case.

For this purpose, a timer unit can also be provided, for example, which is integrated with the control unit 110 and which, when the corresponding load reaches the position sensor 124, triggers a predetermined runout time during which the conveyor unit 108 continues to operate in order to take into account the fact that the position sensor 124 is not arranged directly at the corresponding end of the transfer station 100 but is slightly spaced therefrom. In the present case, a stop element 126 in the form of a horizontally positioned rod is also provided at this end of the transfer station 100, which acts as a support for a load transferred to the second transfer point in order to ensure its correct positioning and orientation for acquisition by the narrow-aisle forklift 300.

A corresponding load L transfer operation process from the first transfer point 102 to the second transfer point 104 will now be explained step by step with reference to the further schematic FIGS. 2a to 2e, wherein in the state of FIG. 2a, a load L in the form of a pallet has first been placed at the first transfer point 102 by the pallet shuttle 200. In this case, the ultrasonic sensor 120 initially detects the presence of the pallet shuttle 200 in the vicinity of the transfer station 100, and the operation of the conveyor unit 108 is suspended. However, as soon as the pallet shuttle 200 has moved out of the detection range of the ultrasonic sensor 120, a safe transfer of the load L from the first transfer point 102 to the second transfer point 104 can begin. In the same way, the capacitive sensor 122 can determine in parallel that there is currently no vehicle in the vicinity of the second transfer point 104.

In this context, the control unit 110 first determines the presence of the load L at the first transfer point 102 on the basis of data from the first occupancy sensor 116, thereby starting the operating process, since at the same time the second occupancy sensor 118 ensures that the second transfer point 104 is not currently occupied by a load, so that a safe transfer of the load L from the first transfer point 102 to the second transfer point 104 is possible.

Since all the requirements for a safe transfer of the load L are now met, i.e. both the absence of a vehicle in the area of the ultrasonic sensor 120 and the capacitive sensor 122 and the absence of a load in the area of the second occupancy sensor 118, the conveyor unit 108 is put into operation and the load L passes through the state of FIG. 2b. In the course of its transfer, the load L then leaves the area of the occupancy sensor 116 and enters the area of the second occupancy sensor 118, and then reaches the state of FIG. 2c, in which the position sensor 124 gives the signal that the operation of the conveyor unit 108 is to be terminated because the load L has arrived in the area of the second transfer point 104 and will come to rest against the stop element 126. For this purpose, by using the timer unit described above, it can be ensured that the spatial distance between the position sensor 124 and the stop element 126 is still compensated for by the fact that the operation of the conveyor unit 108 is not terminated immediately when the load reaches the position sensor 124, but is delayed by a predetermined runout time. This also ensures that any slight inclination of the load is compensated by the load running against the stop element 126.

The load L which has now come to rest in the second transfer point 104 could from now on in principle be taken by the narrow-aisle forklift 300 and transported away from the transfer station 100. At the same time, however, as shown in FIG. 2d, a second load L2 could also be released at the first transfer point 102 by the pallet shuttle 200 or another corresponding pallet shuttle. Even in such a configuration with two loads L and L2, the taking of the first load L by the narrow-aisle forklift truck 300, as shown schematically in FIG. 2e, is possible without any problems, whereupon it would then be determined by means of the second occupancy sensor 118 that the second transfer point 104 has become free, so that the method described here can start again from the state in FIG. 2a.

It should be noted at this point that a corresponding process could of course also take place in the opposite direction. That is, a transfer of a load from the second transfer point 104 to the first transfer point 102 is also possible. Accomplishing this would require merely an opposite operation of the conveyor unit 108 and a corresponding suitable evaluation of the data supplied by the occupancy sensors 116 and 118.

In order to be able to carry out the control or coordination of the vehicles 200 and 300 involved as required in the method illustrated by means of FIGS. 2a to 2e, these are each in wireless data connection with a warehouse management system 400, which is only shown schematically in FIG. 1 and which monitors the current occupancy status of the transfer station 100 solely on the basis of data supplied by the two vehicles 200 and 300. The transfer station 100 itself has no communication channel to the warehouse management system 400.

The warehouse management system 400 always knows the current occupancy status of the transfer station 100—i.e. it knows whether there are currently no, one or two loads at the transfer station 100—by virtue of the fact that the vehicles 200 and 300 each provide information about whether such loads have been transferred to the transfer station 100 or have been transported away from it, and the corresponding information is translated by the warehouse management system into a current occupancy status of the transfer station 100.

In this case, after a load has been released by the pallet shuttle 200 to the first transfer point 102 in a state in which the warehouse management system 400 knows that only this single load is present at the transfer station 100 and a second load is also to be placed there, a certain waiting time can first be provided in order to ensure that the transfer of the corresponding load from the first transfer point 102 to the second transfer point 104, as shown in FIGS. 2a and 2c, has been completed. After this waiting time, the warehouse management system 400 assumes that the first transfer point 102 is then free again to accept another load, since the last load deposited has been automatically transferred to the second transfer point 104. In this way, the warehouse management system not only knows whether and which load is located at the transfer station, but also at which position of the transfer station—i.e., in particular whether the load is located at transfer point 102 or 204.

If, as indicated in FIG. 2e, the narrow-aisle forklift 300 then acquires the corresponding load from the transfer station 100, it also sends corresponding information to the warehouse management system 400, which then, after the waiting time just described, again assumes that a load is only present at the second transfer point 104. If, however, a second load has been delivered in the meantime, but the load then present in the second transfer point 104 has also been transported away by the narrow-aisle forklift 300, the warehouse management system 400 can conclude on the basis of the information provided by the narrow-aisle forklift 300 that two loads have been delivered and also transported away again, so that the transfer station 100 is completely empty and it will be possible to bring one or two loads to the second transfer point 104 to transfer these loads with a corresponding intervening time delay.

1. A transfer station for loads in logistics facilities, comprising:
two transfer points of different types for loads, each transfer points configured in such a way that a load transport vehicle of an associated vehicle type can acquire and release each load;
a conveyor unit configured to transport the loads between the two transfer points; and
a self-sufficient electrical system having a control unit configured to be supplied with electrical energy from outside and to automatically control operation of the conveyor unit.

2. The transfer station according to claim 1, wherein the conveyor unit is formed by a chain conveyor with continuous chains.

3. The transfer station according to claim 1, wherein the conveyor unit comprises a motor with contactor control.

4. The transfer station according to claim 1, wherein each of the two transfer points is assigned a corresponding occupancy sensor configured to supply data to the control unit indicating whether the corresponding transfer point is occupied by a load.

5. The transfer station according claim 1, further comprising at least one surroundings sensor configured to supply data to the control unit which indicate whether the load transport vehicle is present in a vicinity of at least one of the two transfer points.

6. The transfer station according to claim 1, further comprising at least one position sensor configured to indicate when a specified load position has been reached during transport of a load between the two transfer points.

7. The transfer station according to claim 6, further comprising a timer unit configured, when the load reaches the position sensor, to trigger a predetermined runout time during which the conveyor unit continues to operate.

8. The transfer station according to claim 1, wherein at least one of the two transfer points is designed such that a load can be placed thereon by a pallet shuttle; and
wherein at least one of the two transfer points is designed such that the load carried thereon can be acquired by at least one of a storage and retrieval machine or a narrow-aisle forklift, or the load can be placed thereon by the at least one of the storage and retrieval machine or the narrow-aisle forklift.

9. The transfer station according to claim 1, wherein at least one of the two transfer points is provided with a stop which is configured to serve as a support for the load in a correct pose for acquisition by the load transport vehicle.

10. The transfer station according to claim 1, further comprising at least one intermediate position arranged on a transport path of the conveyor unit between the two transfer points to temporarily hold the load.

11. A system comprising: a transfer station and two load transport vehicles, wherein the two load transport vehicles are of different types, and wherein the transfer station comprises:
two transfer points of different types for loads, each transfer points configured in such a way that one of the load transport vehicles can acquire and release each load;
a conveyor unit configured to transport the loads between the two transfer points; and
a self-sufficient electrical system having a control unit configured to be supplied with electrical energy from outside and to automatically control operation of the conveyor unit.

12. The system according to claim 11, further comprising a warehouse management system;
wherein information about loads acquired at the transfer station or placed thereon is only transmitted from the two load transport vehicles to the warehouse management system.

13. A method for operating a system, for transferring a load from a first load transport vehicle of a first type to a second load transport vehicle of a second type, comprising the steps of:
releasing the load, by the first load transport vehicle, at a first transfer points of a transfer station;
detecting, by a first occupancy sensor assigned to the first transfer point, the load is present at the first transfer point;
operating a conveyor unit of the transfer station to transport the load from the first transfer point towards a second transfer point of the transfer station provided that a second occupancy sensor assigned to the second transfer point does not detect a second load present at the second transfer point;
detecting, by a position sensor, when the load has reached the second transfer point;
in response to detecting that the load has reached the second transfer point, terminating the operation of the conveyor unit; and
acquiring the load, by the second load transport vehicle, at the second transfer point.

14. The method according to claim 13, further comprising: transmitting information to a warehouse management system, by the first load transport vehicle, regarding the release of the load at the first transfer point, and comprising: transmitting information to the warehouse management system, by the second load transport vehicle, regarding acquisition of the load at the second transfer point.

15. The method according to claim 13, further comprising, prior to operating the conveyor unit, a step of checking a surrounding area of the first transfer point for an absence of the first load transport vehicle.

16. The transfer station according to claim 3, wherein the conveyor unit does not include a frequency converter or electronic controller.

17. The transfer station according claim 5, wherein the at least one surroundings sensor comprises an ultrasonic sensor or a capacitive sensor.

18. The transfer station according to claim 6, wherein the at least one position sensor comprises a light barrier.

19. The transfer station according to claim 1, wherein the transfer points are designed such that a pallet shuttle can pass under a first of the transfer points while carrying the load, and the at least one of a storage and retrieval machine or a narrow-aisle forklift can acquire the load from or place the load on a second of the transfer points.
